(19) United States
(12) Patent Application Publication
(10) Pub. No.: US 2026/0037995 A1
(43) Pub. Date: Feb. 5, 2026

(54) MARKET DESCRIPTION EVENT EXTRACTION METHOD AND SYSTEM

(71) Applicant: SK HOLDINGS CO., LTD., Seoul (KR)

(72) Inventors: Hyung Jun MOON, Seoul (KR); Bo Kwan JEON, Seongnam-si (KR); Kang Hun LEE, Seoul (KR)

(73) Assignee: SK HOLDINGS CO., LTD., Seoul (KR)

(21) Appl. No.: 18/842,907

(22) PCT Filed: Mar. 2, 2023
(86) PCT No.: PCT/KR2023/002838

§ 371 Date: Mar. 17, 2025

(30) Foreign Application Priority Data
Mar. 3, 2022 (KR) 10-2022-0027280

(51) Int. Cl. G06Q 30/0202; G06Q 40/04

(52) U.S. Cl. CPC G06Q 30/02022; G06Q 40/0421

(57) ABSTRACT

A market explanation event extraction method includes a step of acquiring, by a market explanation event extraction system, a stock price index data and unstructured data of a text type for predicting a stock price, a step of extracting, by the market explanation event extraction system, an event that influences a stock market based on the acquired unstructured data, a step of predicting, by the market explanation event extraction system, a future direction of a stock price by analyzing the extracted event, and a step of selecting, by the market explanation event extraction system, an event that matches a result of predicting the direction by comparing the result of predicting the direction and an actual stock price index, and extracting a market explanation event that explains a cause of a rise or fall of a stock price based on the selected event.

### TECHNICAL FIELD

The disclosure relates to a method and a system for extracting an event of a stock market, and more particularly, to a method and a system for extracting and analyzing an event based on unstructured data, such as economics-related news articles, market prospect reports, and policy reports, which affect a stock price index.

### BACKGROUND ART

The stock market has a unique pricing mechanism, and this pricing mechanism may be affected by innumerable variable data.

Traditionally, in order to predict price volatility of the stock market, experts directly analyze based on much variable data.

Variable data may include unstructured data such as economics-related news articles, market prospect reports, policy reports, etc.

Recently, techniques are developing to analyze such unstructured data and to predict stock price volatility, but they do not provide grounds for prediction results, and thus brokerage firm employees or individual stock investors, who use prediction results, do not trust the prediction results or have limitations to using the prediction results.

Accordingly, there is a demand for a method for providing a market explanation event, which predicts the direction of a stock price by extracting and analyzing an event based on unstructured data, and explains grounds for prediction results or the cause of actual stock price rise or fall.

### DISCLOSURE

### Technical Problem

The disclosure has been developed in order to address the above-discussed deficiencies of the prior art, and an object of the disclosure is to provide a method and a system for providing a market explanation event, which predict the direction of a stock price by extracting and analyzing an event based on unstructured data, and explain grounds for prediction results and the cause of actual stock price rise or fall.

### Technical Solution

According to an embodiment of the disclosure to achieve the above-described object, a market explanation event extraction method may include: a step of acquiring, by a market explanation event extraction system, a stock price index data and unstructured data of a text type for predicting a stock price; a step of extracting, by the market explanation event extraction system, an event that influences a stock market based on the acquired unstructured data; a step of predicting, by the market explanation event extraction system, a future direction of a stock price by analyzing the extracted event; and a step of selecting, by the market explanation event extraction system, an event that matches a result of predicting the direction by comparing the result of predicting the direction and an actual stock price index, and extracting a market explanation event that explains a cause of a rise or fall of a stock price based on the selected event.

The step of extracting the event may include inputting the acquired unstructured data to an unsupervised learning model, and extracting an event whose correlation with a stock index is greater than or equal to a pre-set first threshold value.

The step of predicting the direction may include: a step of analyzing the extracted event and classifying the even type into a market event that influences the entirety or a part of the stock market, a corporation event that influences a specific corporation, or an industry event that influences a specific industry; and a step of predicting the future direction of the stock price according to the classified event type; and a step of calculating a prediction accuracy of the predicted direction.

The step of extracting the market explanation event may include: a step of selecting an event that matches the result of predicting the direction by comparing the result of predicting the direction and the actual stock price index; and a step of determining an event whose prediction accuracy is greater than or equal to a second threshold value among the selected events as the market explanation event.

According to an embodiment of the disclosure, the market explanation event extraction method may further include a step of analyzing, by the market explanation event extraction system, a plurality of market explanation events, and grouping market explanation events whose correlation with one another is greater than or equal to a pre-set third threshold value.

The step of grouping may include grouping market explanation events whose correlation with one another is greater than or equal to the pre-set third threshold value with reference to a prediction accuracy, a range of a target influenced, and a range of stock price fluctuation caused by an event.

The step of grouping may include, when the market event that influences the entirety or a part of the stock market or an industry event that influences a specific industry occurs, extracting information on an actual price index and a stork price direction in the past when other market explanation events of the same group as that of the occurred market event or industry event occurred.

The step of extracting the market explanation event ma include, when a discrepancy event that is discrepant with the prediction result is selected as a result of comparing the result of predicting the direction and the actual stock price, extracting, as an unexplainable event, a discrepancy event that does not provide any rationale for direction prediction of the discrepancy event among the selected discrepancy events.

In addition, the step of grouping may include grouping all events that are extracted as unexplainable events and all events that are extracted as market explanation events into the same group when the event types of all the events classified in the direction prediction process for a pre-set effective period belong to the same category, and, if an event belonging to the same event type as the grouped events is extracted, the market explanation event extraction system provides information on previous prediction results of the grouped events and an actual stock price index when predicting a stock price direction of the extracted event.

According to another embodiment, a market explanation event extraction system may include: a communication system configured to acquire a stock price index data and unstructured data of a text type for predicting a stock price; a processor configured to extract an event that influences a stock market based on the acquired unstructured data, to predict a future direction of a stock price by analyzing the extracted event, to select an event that matches a result of predicting the direction by comparing the result of predicting the direction and an actual stock price index, and to extract a market explanation event that explains a cause of a rise or fall of a stock price based on the selected event.

### Advantageous Effects

As described above, according to embodiments of the disclosure, an event may be extracted based on unstructured data, and a direction of a stock price may be extracted by analyzing the event, and a market explanation event that can explain grounds for prediction results or the cause of actual stock prices rise or fall may also be provided.

### DESCRIPTION OF DRAWINGS

FIG. 1 is a view provided to explain a market explanation event extraction system according to an embodiment of the disclosure;

FIG. 2 is a view provided to explain a processor according to an embodiment of the disclosure;

FIG. 3 is a view provided to explain provision of a stock price index and a market explanation event;

FIG. 4 is a view illustrating grouped market explanation events; and

FIG. 5 is a view provided to explain a market explanation event extraction method according to an embodiment of the disclosure.

### BEST MODE

Hereinafter, the disclosure will be described in more detail with reference to the drawings.

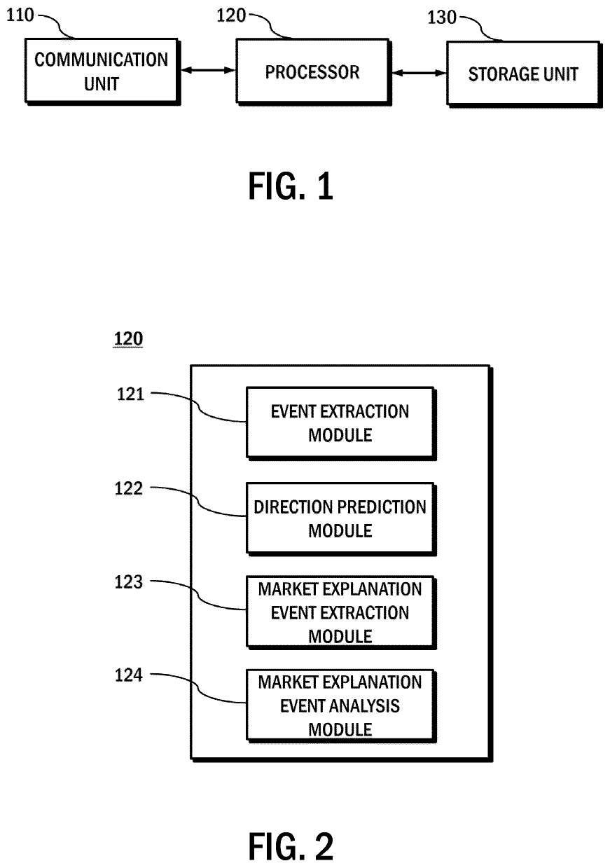

FIG. 1 is a view provided to explain a market explanation event extraction system according to an embodiment of the disclosure.

The market explanation event extraction system according to an embodiment may extract an event based on unstructured data, may predict the direction of a stock price by analyzing, and may explain grounds for prediction results or the cause of actual stock price rise or fall.

To achieve this, the market explanation event extraction system may include a communication unit 110, a processor 120, and a storage unit 130.

The communication unit 110 may be a communication means provided to connect to, through a communication network, a server that provides stock price indexes, a server that provides an Internet search engine service, and a server that operates a news site, and a user terminal that provides information calculated through the processor 120.

Specifically, the communication unit 110 may connect to the server that provides the stock price indexes, the server that provides the Internet search engine service, and the server that operates the news site through the communication network, and may acquire text type-unstructured data for predicting stock prices, such as data on stock price indexes and economics-related news articles.

Here, the text-type unstructured data for predicting stock prices may include national news articles, foreign news articles, market prospect reports and policy reports, etc.

The storage unit 130 may be a storage medium that stores programs and data necessary for operations of the processor 120.

The processor 120 may process overall operations of the market explanation event extraction system to extract an event based on unstructured data and to predict the direction of a stock price by analyzing, and to extract a market explanation event capable of explaining grounds for prediction results or the cause of actual stock price rise or fall and to provide the market explanation event to a user.

Specifically, the processor 120 may extract an event that influences a stock market based on unstructured data which is acquired through the communication unit 110, and may predict the future direction of a stock price by analyzing the extracted event.

In addition, the processor 120 may compare the result of predicting the direction and an actual stock price index, may select an event that matches the result of predicting the direction, may extract a market explanation event that can explain the cause of stock price rise or fall, based on the selected event, may analyze a plurality of market explanation events, and may group the market explanation events whose correlation with one another is greater than or equal to a pre-set third threshold value.

This will be described in detail below with reference to FIGS. 2 to 4.

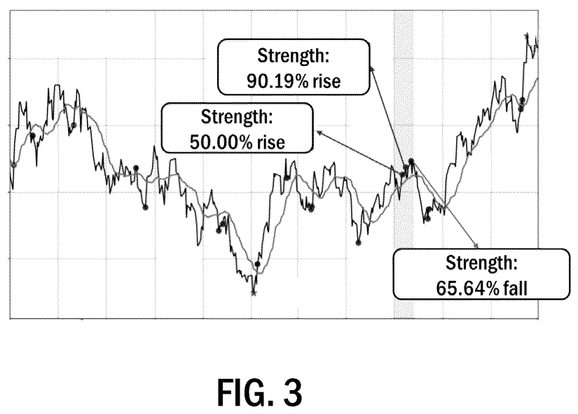

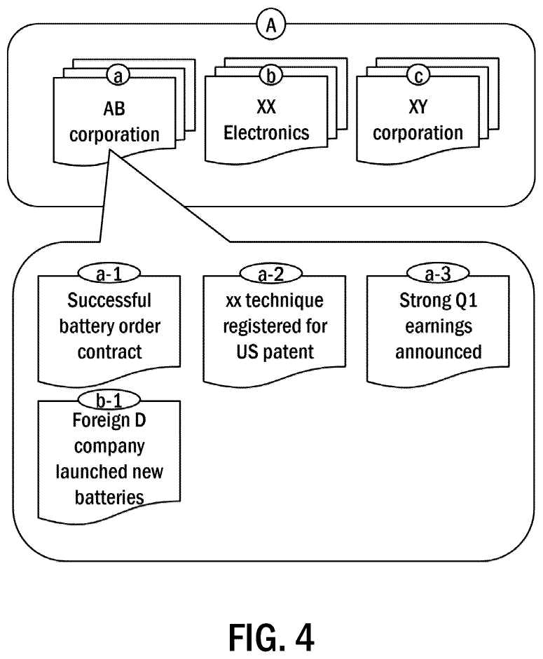

FIG. 2 is a view provided to explain the processor 120 according to an embodiment of the disclosure, FIG. 3 is a view illustrating provision of a stock price index and a market explanation event, and FIG. 4 is a view illustrating grouped market explanation events.

Referring to FIG. 2, the processor 120 may include an event extraction module 121, a direction prediction module 122, a market explanation event extraction module 123, and a market explanation event analysis module 124.

The event extraction module 121 may extract an event that influences a stock market based on unstructured data acquired through the communication unit 110.

For example, the event extraction module 121 may input the acquired unstructured data to an event extraction model which is an unsupervised learning model, and may extract an event whose correlation with a stock price index is greater than or equal to a pre-set first threshold value.

That is, the event extraction module 121 may extract an economics-related news article that influences the stock market among news articles published on Internet search engine services and news sites through the communication unit 110, and may transmit the extracted news article to the direction prediction module 122.

The direction prediction module 122 may analyze the extracted event and may predict the future direction of a stock price as a rise or fall.

Specifically, the direction prediction module 122 may analyze the extracted event, may classify the event type into a market event that influences the entirety or a part of the stock market, a corporation event that influences a specific corporation, or an industry event that influences a specific industry, and may predict the future direction of the stock price according to the classified event type.

That is, the direction prediction module 122 may classify the news articles extracted through the event extraction module 121 by event types, and may predict the direction of the stock price according to each news article, and may provide not only the direction of the stock price according to the event type, but also the time period that influences the stock price, classified into a temporary period, a short-term period, and a long-term period.

In addition, the direction prediction module 122 may calculate a prediction accuracy of the predicted direction (=prediction strength).

The direction prediction module 122 may calculate a predicted direction and a prediction accuracy with respect to each news article, but since a plurality of news articles may be written about a specific stock item or a specific industry, each news article (each event) may have a conflicting prediction direction.

For example, the direction prediction module 122 may calculate a 40% probability of a fall of an overall stock price index, a stock price index of a specific item or the same industry based on article A, and may calculate a 60% probability of a rise based on article B.

Accordingly, when there is a conflict in the predicted directions according to events (news articles), the market explanation event extraction module 123 may compare a result of predicting the direction and an actual stock price index, and may select an event that matches the result of predicting the direction, and may extract a market explanation event capable of explaining the cause of stock price rise or fall based on the selected event.

Specifically, the market explanation event extraction module 123 may compare the result of predicting the direction and the actual stock price index, and may select the event that matches the result of predicting the direction, and may determine, as a market explanation event, the event whose prediction accuracy is greater than or equal to a pre-set second threshold value among the selected events.

That is, if the pre-set second threshold value is 35%, the market explanation event extraction module 123 may select news articles showing that the predicted direction matches the actual stock price index among the news articles predicted through the direction prediction module 122, and may determine a news article whose prediction accuracy is greater than or equal to 35% among the selected news articles as a market explanation event.

The reason why the news article whose prediction accuracy is less than the second threshold value is excluded is that there is a high possibility that the direction of the stock price index of this article coincidently matches or contents of the corresponding news articles is not appropriate as grounds for a rise or fall of the stock price.

FIG. 3 is a view illustrating a stock price index and a market explanation event which are provided through a user terminal.

The market explanation event analysis module 124 may analyze a plurality of market explanation events, and may group the market explanation events whose correlation with one another is greater than or equal to the pre-set third threshold value.

Specifically, the market explanation event analysis module 124 may group the market explanation events whose correlation with one another is greater than or equal to the pre-set third threshold value with reference to the prediction accuracy (=prediction strength), the range of targets influenced, the range of stock price fluctuation caused by an event.

For example, the market explanation event analysis module 124 may group (A group) the news articles that are extracted as market explanation events among news articles on domestic secondary battery manufacturers as shown in FIG. 4.

In the A group, news articles that are extracted as market explanation events among news articles about the AB corporation may be configured as a sub-group (a), and the sub-group (a) may include news articles a-1, a-2, a-3 that can explain the cause of a rise of the stock price of the AB corporation, and news articles b-1 that can explain the cause of a fall of the stock price.

In another example, when a market event that influences the entirety or a part of the stock market or an industry event that influences a specific industry occurs, the market explanation event analysis module 124 may extract information on the actual stock price index and the stock price direction in the past when other market explanation events of the same group, including the occurred market event or industry event, occurred.

That is, when a market explanation event (news article) indicating that a foreign D company, which is a rival company of the AB corporation, will launch new batteries is extracted, the market explanation event analysis module 124 may provide, through a user terminal, information on the actual stock price of the AB corporation, and the prediction direction of the stock price index, and the prediction accuracy in the past when the XY corporation, which is another rival company, launched new batteries.

In addition, the market explanation event analysis module 124 may compare the result of predicting the direction and the actual stock price index, and, when a discrepancy event that is discrepant with the prediction result is selected, the market explanation event analysis module 124 may extract, as an unexplainable event, a discrepancy event that does not provide any rationale for direction prediction of the discrepancy event among the selected discrepancy events, and may group all events that are extracted as unexplainable events and all events that are extracted as market explanation events into the same group when the event types of all the events classified in the direction prediction process for a pre-set effective period belong to the same category.

Through this, when an event belonging to the same event type as the grouped events is extracted, the market explanation event analysis module 124 may provide information on previous prediction results of the grouped events and the actual stock price through the user terminal when predicting the direction of the stock price of the extracted event.

Here, the unexplainable event may include an event that has different influence on the actual stock price index from other events among the events (news articles) classified into the same event type.

In addition, the market explanation event analysis module 124 may extract a correlation between stock market volatility by industry and company, and a specific market explanation event group.

In addition, the market explanation event analysis module 124 may extract an event type that most influences stock volatility of a specific industry or company by applying an ensemble model, and may provide the extracted event type through a user terminal.

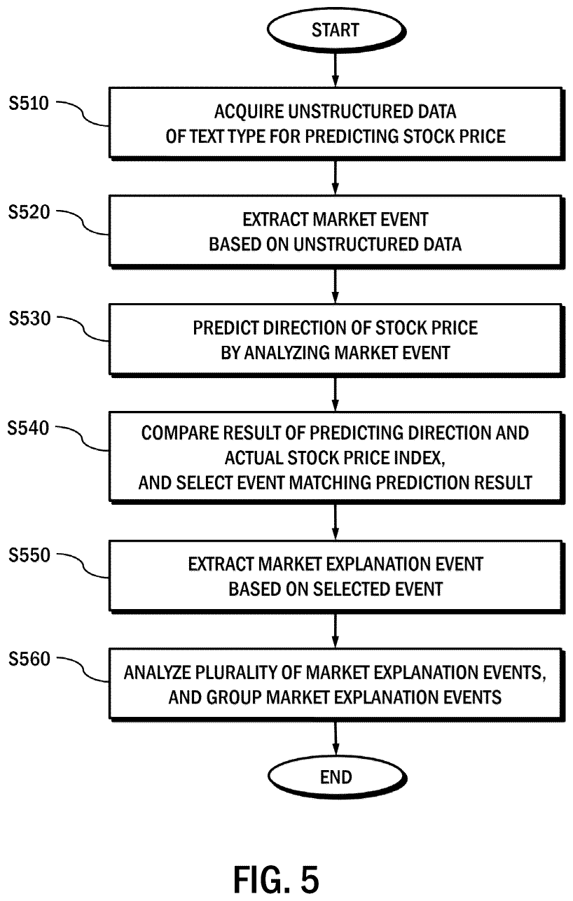

FIG. 5 is a view provided to explain a market explanation event extraction method according to an embodiment of the disclosure

The market explanation event extraction method according to an embodiment may be executed by the market explanation event extraction system described above with reference to FIGS. 1 to 4.

The market explanation event extraction method may acquire unstructured data of text types for predicting stock prices, such as a stock price index data and economics-related news articles (S510), may extract an event that influences the stock market, based on the acquired unstructured data (S520), and may predict the future direction of the stock price by analyzing the extracted event (S530).

The market explanation event extraction method may select an event that matches the result of predicting the direction by comparing the result of predicting the direction and an actual stock price index (S540), may extract a market explicable event that can explain the cause of a rise or fall of the stock price, based on the selected event (S550), and may analyze a plurality of market explanation events and may group market explanation events whose correlation with one another is greater than or equal to a pre-set third threshold value (S560).

Through this, the direction of a stock price may be predicted by extracting and analyzing an event based on unstructured data, and a market explanation event that can explain grounds for the prediction results or the cause of actual stock price rise or fall may also be provided.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. A market explanation event extraction method comprising:
a step of acquiring, by a market explanation event extraction system, a stock price index data and unstructured data of a text type for predicting a stock price;
a step of extracting, by the market explanation event extraction system, an event that influences a stock market based on the acquired unstructured data;
a step of predicting, by the market explanation event extraction system, a future direction of a stock price by analyzing the extracted event; and
a step of selecting, by the market explanation event extraction system, an event that matches a result of predicting the direction by comparing the result of predicting the direction and an actual stock price index, and extracting a market explanation event that explains a cause of a rise or fall of a stock price based on the selected event.

2. The market explanation event extraction method of claim 1, wherein the step of extracting the event comprises inputting the acquired unstructured data to an unsupervised learning model, and extracting an event whose correlation with a stock index is greater than or equal to a pre-set first threshold value.

3. The market explanation event extraction method of claim 1, wherein the step of predicting the direction comprises:
a step of analyzing the extracted event and classifying the even type into a market event that influences the entirety or a part of the stock market, a corporation event that influences a specific corporation, or an industry event that influences a specific industry; and
a step of predicting the future direction of the stock price according to the classified event type; and
a step of calculating a prediction accuracy of the predicted direction.

4. The market explanation event extraction method of claim 3, wherein the step of extracting the market explanation event comprises:
a step of selecting an event that matches the result of predicting the direction by comparing the result of predicting the direction and the actual stock price index; and
a step of determining an event whose prediction accuracy is greater than or equal to a second threshold value among the selected events as the market explanation event.

5. The market explanation event extraction method of claim 4, further comprising a step of analyzing, by the market explanation event extraction system, a plurality of market explanation events, and grouping market explanation events whose correlation with one another is greater than or equal to a pre-set third threshold value.

6. The market explanation event extraction method of claim 5, wherein the step of grouping comprises grouping market explanation events whose correlation with one another is greater than or equal to the pre-set third threshold value with reference to a prediction accuracy, a range of a target influenced, and a range of stock price fluctuation caused by an event.

7. The market explanation event extraction method of claim 6, wherein the step of grouping comprises, when the market event that influences the entirety or a part of the stock market or an industry event that influences a specific industry occurs, extracting information on an actual price index and a stork price direction in the past when other market explanation events of the same group as that of the occurred market event or industry event occurred.

8. The market explanation event extraction method of claim 5, wherein the step of extracting the market explanation event comprises, when a discrepancy event that is discrepant with the prediction result is selected as a result of comparing the result of predicting the direction and the actual stock price, extracting, as an unexplainable event, a discrepancy event that does not provide any rationale for direction prediction of the discrepancy event among the selected discrepancy events.

9. The market explanation event extraction method of claim 8, wherein the step of grouping comprises grouping all events that are extracted as unexplainable events and all events that are extracted as market explanation events into the same group when the event types of all the events classified in the direction prediction process for a pre-set effective period belong to the same category, and
wherein, if an event belonging to the same event type as the grouped events is extracted, the market explanation event extraction system provides information on previous prediction results of the grouped events and an actual stock price index when predicting a stock price direction of the extracted event.

10. A market explanation event extraction system comprising:
a communication system configured to acquire a stock price index data and unstructured data of a text type for predicting a stock price;
a processor configured to extract an event that influences a stock market based on the acquired unstructured data, to predict a future direction of a stock price by analyzing the extracted event, to select an event that matches a result of predicting the direction by comparing the result of predicting the direction and an actual stock price index, and to extract a market explanation event that explains a cause of a rise or fall of a stock price based on the selected event.
